(19) United States
(12) Patent Application Publication
(10) Pub. No.: US 2023/0186379 A1
(43) Pub. Date: Jun. 15, 2023

(54) TRANSPORT MANAGEMENT DEVICE, TRANSPORT MANAGEMENT SYSTEM, AND TRANSPORT MANAGEMENT METHOD

(71) Applicant: PANASONIC INTELLECTUAL PROPERTY MANAGEMENT CO., LTD., Osaka (JP)

(72) Inventors: Satoshi TSUCHIYA, Tokyo (JP); Yohei JIN, Osaka (JP); Satoshi FUJIKAWA, Kanagawa (JP)

(73) Assignee: PANASONIC INTELLECTUAL PROPERTY MANAGEMENT CO., LTD., Osaka (JP)

(21) Appl. No.: 18/104,949

(22) Filed: Feb. 2, 2023

Related U.S. Application Data
(63) Continuation of application No. PCT/JP2021/021621, filed on Jun. 7, 2021.

(30) Foreign Application Priority Data
Aug. 5, 2020 (JP) 2020-133266

(51) Int. Cl. G06Q 30/0645; G06Q 10/02; G06Q 50/30; B60R 25/24; B60R 25/04

(52) U.S. Cl. CPC G06Q 30/0645; G06Q 10/02; G06Q 50/30; B60R 25/24; B60R 25/04; B60R 2325/20

(57) ABSTRACT

A transport management device is configured to manage transport of a vehicle for rent. The transport management device includes: a memory; and a processor that is coupled to the memory, and when executing a program stored in the memory, performs operations. The operations include: determining, based on transporter information including information about one or more transporters who transport the vehicle between an owner of the vehicle and a renter of the vehicle, a first transporter from among the one or more transporters, the first transporter being capable of picking up the vehicle at a first point designated by the owner and transporting the vehicle picked up at the first point to a second point designated by the renter; and transmitting, to a terminal of the first transporter, first transport request information including information indicating the first point and the second point.

### CROSS-REFERENCE TO RELATED APPLICATIONS

This is a continuation of International Application No. PCT/JP2021/021621 filed on Jun. 7, 2021, and claims priority from Japanese Patent Application No. 2020-133266 filed on Aug. 5, 2020, the entire content of which is incorporated herein by reference.

### TECHNICAL FIELD

The present disclosure relates to a transport management device, a transport management system, and a transport management method for a vehicle.

### BACKGROUND ART

A car rental service, a car sharing service, and the like for renting out a vehicle to a user who wants to temporarily use the vehicle are known.

For example, J2020-046946A discloses the following car sharing server. That is, the car sharing server presents a list of rentable vehicles managed by each agency and a rentable period of each vehicle to a user terminal owned by a user. The car sharing server receives, from the user terminal, designation of a vehicle desired to be used from the list, and receives reservation information including a use period of the vehicle and designation of a delivery place of the vehicle with an agency managing the vehicle.

### SUMMARY OF INVENTION

However, in the service described in JP2020-046946A, the user who rents the vehicle needs to go to a delivery point designated by the agency who rents out the vehicle to pick up the vehicle. That is, in the car rental service, the car sharing service, and the like of related art, a load of moving to the delivery point of the vehicle is large for the user who rents the vehicle. For example, in a case where a user is elderly, ill, injured, or accompanied by children, in a case where there are many baggages of the user, and in a case of bad weather, a movement load is particularly large.

An aspect of the present disclosure provides a transport management device, a transport management system, and a transport management method capable of efficiently transporting a vehicle between an owner and a renter of the vehicle.

The present disclosure provides a transport management device configured to manage transport of a vehicle for rent, the transport management device including: a memory; and a processor that is coupled to the memory, and when executing a program stored in the memory, performs operations including: determining, based on transporter information including information about one or more transporters who transport the vehicle between an owner of the vehicle and a renter of the vehicle, a first transporter from among the one or more transporters, the first transporter being capable of picking up the vehicle at a first point designated by the owner and transporting the vehicle picked up at the first point to a second point designated by the renter; and transmitting, to a terminal of the first transporter, first transport request information including information indicating the first point and the second point.

The present disclosure provides a transport management system configured to manage transport of a vehicle for rent, the transport management system including: one or more terminals of respective one or more transporters who transport the vehicle between an owner of the vehicle and a renter of the vehicle; and a transport management device, wherein the transport management device includes: a memory; and a processor that is coupled to the memory, and when executing a program stored in the memory, performs operations including: determining, based on transporter information including information about the one or more transporters, a first transporter from among the one or more transporters, the first transporter being capable of picking up the vehicle at a first point designated by the owner and transporting the vehicle picked up at the first point to a second point designated by the renter; and transmitting, to a terminal of the first transporter among the one or more terminals, first transport request information including information indicating the first point and the second point.

The present disclosure provides a transport management method for managing transport of a vehicle for rent by a transport management device, the transport management method including: determining, based on transporter information including information about one or more transporters who transport the vehicle between an owner of the vehicle and a renter of the vehicle, a first transporter from among the one or more transporters, the first transporter being capable of picking up the vehicle at a first point designated by the owner and transporting the vehicle picked up at the first point to a second point designated by the renter; and transmitting, to a terminal of the first transporter, first transport request information including information indicating the first point and the second point.

These comprehensive or specific aspects may be implemented by a system, a device, a method, an integrated circuit, a computer program, or a recording medium, or may be implemented by any combination of the system, the device, the method, the integrated circuit, the computer program, and the recording medium.

According to an aspect of the present disclosure, it is possible to efficiently transport a vehicle between an owner and a renter of the vehicle.

### BRIEF DESCRIPTION OF DRAWINGS

The present disclosure will be described in detail based on the following figures, wherein:

FIG. 1 is a schematic diagram illustrating a configuration example of a transport management system according to the present embodiment;

FIG. 2 is a block diagram illustrating a configuration example of a transport management device according to the present embodiment;

FIG. 3 is a sequence chart illustrating an operation example of the transport management system related to registration of information in an information storage unit and an update of information in the information storage unit;

FIG. 4A is a sequence chart illustrating an operation example of the transport management system in a case where a renter selects a transporter when renting a vehicle and the selected transporter transports the vehicle for rent to a place designated by the renter;

FIG. 4B is a sequence chart illustrating a continuation in FIG. 4A;

FIG. 4C is a sequence chart illustrating a continuation in FIG. 4B;

FIG. 5 is a sequence chart illustrating an operation example of the transport management system in a case where an owner selects a transporter when renting out the vehicle and the selected transporter transports the vehicle for rent to the place designated by the renter;

FIG. 6A is a sequence chart illustrating an operation example of the transport management system in a case where the renter selects a transporter when returning the vehicle and the selected transporter picks up the vehicle for return to a place designated by the renter;

FIG. 6B is a sequence chart showing a continuation in FIG. 6A;

FIG. 6C is a sequence chart showing a continuation in FIG. 6B; and

FIG. 7 is a diagram illustrating a hardware configuration of a computer that implements functions of the transport management device according to the present disclosure by a program.

### DESCRIPTION OF EMBODIMENTS

Hereinafter, an embodiment of the present disclosure will be described in detail with reference to the drawings as appropriate. However, an unnecessarily detailed description may be omitted. For example, detailed descriptions of well-known matters and repeated descriptions of substantially the same configurations may be omitted. This is to avoid unnecessary redundancy in the following description and to facilitate understanding for those skilled in the art. The accompanying drawings and the following description are provided for those skilled in the art to fully understand the present disclosure, and are not intended to limit the subject matter described in the claims.

### Present Embodiment

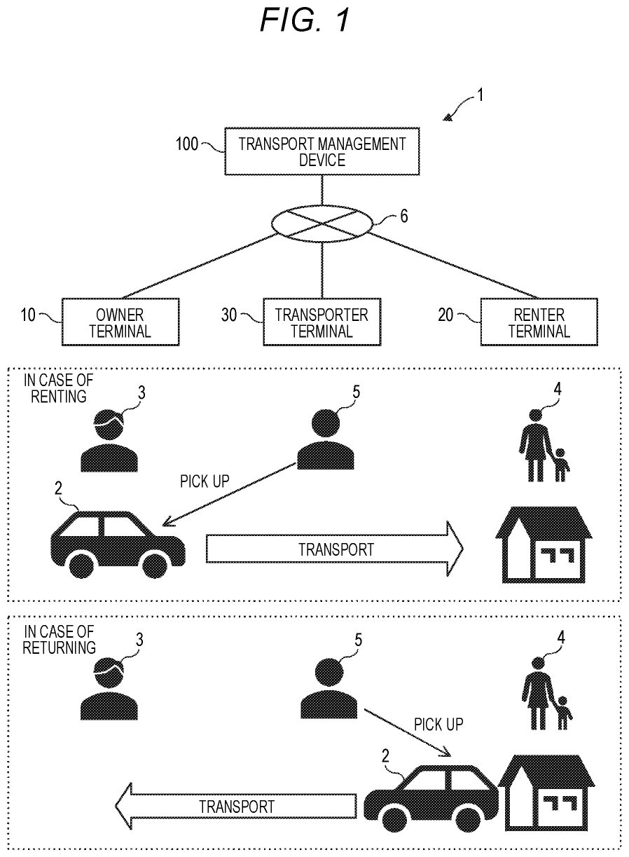

FIG. 1 is a schematic diagram illustrating a configuration example of a transport management system 1 according to the present embodiment.

A car rental service, car sharing service, and the like for renting out a vehicle to a user who wants to temporarily use a vehicle 2 are known. The car sharing service is a service in which the vehicle 2 owned by a company or an individual is shared by a plurality of users.

In related art, a user 4 who rents the vehicle 2 needs to go to a rent-out point designated by an owner 3 to rent the vehicle 2 at the time of renting, and to go to a return point designated by the owner 3 to return the vehicle 2 at the time of returning. The user 4 who rents the vehicle 2 is hereinafter referred to as a renter 4. For example, when the owner 3 is a car rental company, the renter 4 needs to go to a store to rent the vehicle 2 at the time of renting, and to go to the store to return the vehicle 2 at the time of returning. When the owner 3 is a car sharing company, the renter 4 needs to go to a parking lot in which the vehicle 2 is placed to take the vehicle 2 at the time of renting, and to go to the parking lot to return the vehicle 2 at the time of returning. That is, in the car rental service and the car sharing service of the related art, a movement load such as going to take the vehicle 2 or going home from a point where the vehicle 2 is returned is large for the renter 4.

The transport management system 1 according to the present embodiment determines an entity or person 5 who transports the vehicle 2 to a point designated by the renter 4 at the time of renting or picks up the vehicle 2 at the point designated by the renter 4 and returns the vehicle 2 instead of the renter 4 at the time of returning. Hereinafter, the entity or person 5 which transports the vehicle 2 to the point designated by the renter 4 or picks up the vehicle 2 at the point designated by the renter 4 and returns the vehicle 2 instead of the renter 4 at the time of returning is referred to as the transporter 5. Since the renter 4 can receive the vehicle 2 from the transporter 5 at a designated point at the time of renting, and can hand over the rented vehicle 2 to the transporter 5 at the designated point at the time of returning, the movement load accompanying the renting of the vehicle 2 is reduced.

Next, the transport management system 1 will be described with reference to FIG. 1. The transport management system 1 is a system that manages transport of the vehicle 2, and includes an owner terminal 10, a renter terminal 20, a transporter terminal 30, and a transport management device 100. The owner terminal 10, the renter terminal 20, the transporter terminal 30, and the transport management device 100 can transmit and receive information to and from each other through a communication network 6. The communication network 6 may include a local area network (LAN), the Internet, a mobile communication network, or a combination thereof, and may be wired or wireless.

The owner terminal 10 is a terminal owned by the owner 3. The renter terminal 20 is a terminal owned by the renter 4. The transporter terminal 30 is a terminal owned by the transporter 5. Examples of the owner terminal 10, the renter terminal 20, or the transporter terminal 30 include a smartphone, a tablet, and a PC.

The transport management device 100 is a device that manages transport of the vehicle 2. The transport management device 100 may include one or a plurality of server devices. A service provided by the transport management device 100 may be referred to as a transport management service. Details of the transport management device 100 will be described later.

In Case of Renting Vehicle

Next, a case where the renter 4 rents the vehicle 2 will be described. When the renter 4 makes a rental reservation for the vehicle 2, the renter 4 designates a delivery point of the vehicle 2 through the renter terminal 20. An example of the delivery point of the vehicle 2 is home of the renter 4. However, the delivery point is not limited to the home, and may be any point such as a nearest station or an accommodation destination of the renter 4. Information about the designated delivery point is transmitted from the renter terminal 20 to the transport management device 100.

The transport management device 100 extracts transporter candidates from among entities or persons who are registered in advance and can accept transport work, and determines the transporter 5 of the vehicle 2 from among the extracted transporter candidates. Hereinafter, an entity or person who is registered in advance and can accept the transport work will be referred to as a registrant. The transporter candidate is an entity or person who can transport the vehicle 2 from the rent-out point of the vehicle 2 reserved for rental to the delivery point of the vehicle 2 designated by the renter 4. Further, the transport management device 100 transmits transport request information, which is information for requesting the transport, to the transporter terminal 30 of the determined transporter 5.

The transport request information transmitted from the transport management device 100 is displayed on the transporter terminal 30. The transporter 5 determines whether to receive the request based on the transport request information displayed on the transporter terminal 30. When the transporter 5 determines to receive the request, the transporter 5 moves to the rent-out point of the vehicle 2 reserved for rental, picks up the vehicle 2, and drives the vehicle 2 to the delivery point designated by the renter 4. Further, the transporter 5 hands over the vehicle 2 to the renter 4 at the delivery point designated by the renter 4. Accordingly, the renter 4 can receive the vehicle 2 at the designated point without moving to the rent-out point of the vehicle 2.

In Case of Returning Vehicle

Next, a case where the renter 4 returns the vehicle 2 will be described. When the renter 4 makes a return reservation for the vehicle 2, the renter 4 designates a delivery point of the vehicle 2 to be returned through the renter terminal 20. An example of the delivery point of the vehicle 2 is home of the renter 4. However, the delivery point is not limited to the home, and may be any point such as a nearest station or an accommodation destination of the renter 4. Information about the designated delivery point is transmitted from the renter terminal 20 to the transport management device 100.

The transport management device 100 extracts transporter candidates from among registrants who are registered in advance, and determines the transporter 5 of the vehicle 2 from the extracted transporter candidates. The transporter candidate is an entity or person who can transport the vehicle 2 from the delivery point of the vehicle 2 designated by the renter 4 at the time of the return reservation to the return point of the vehicle 2 designated by the owner 3. Further, the transport management device 100 transmits the transport request information to the transporter terminal 30 of the determined transporter 5.

The transport request information transmitted from the transport management device 100 is displayed on the transporter terminal 30. The transporter 5 determines whether to receive the request based on the transport request information displayed on the transporter terminal 30. When the transporter 5 determines to receive the request, the transporter 5 moves to the delivery point of the vehicle 2 designated by the renter 4 at the time of the return reservation, picks up the vehicle 2, and drives the vehicle 2 to the return point of the vehicle 2 designated by the owner 3. Further, the transporter 5 returns the vehicle 2 at the return point. Accordingly, the renter 4 can return the vehicle 2 at the designated point without driving the vehicle 2 to the return point. Hereinafter, the present embodiment will be described in detail.

Configuration of Transport Management Device

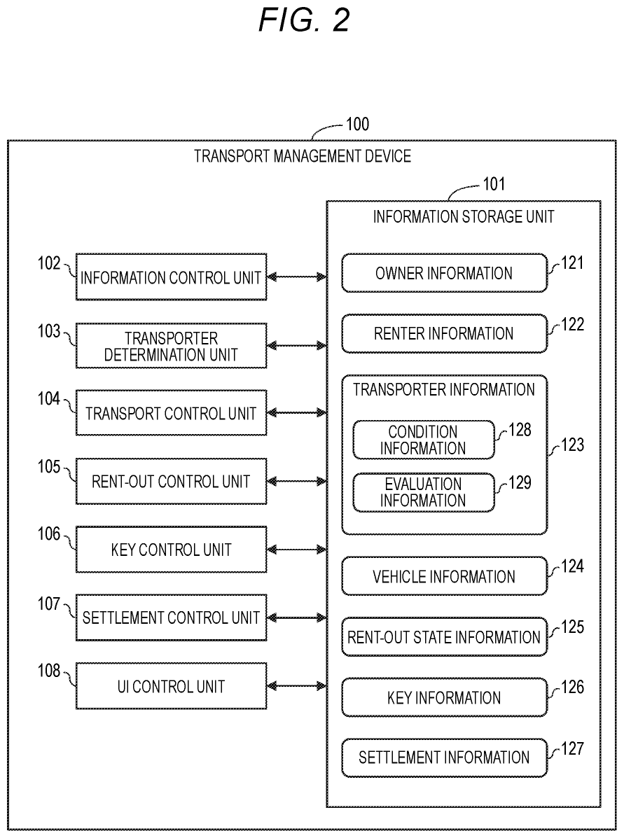

FIG. 2 is a block diagram illustrating a configuration example of the transport management device 100 according to the present embodiment.

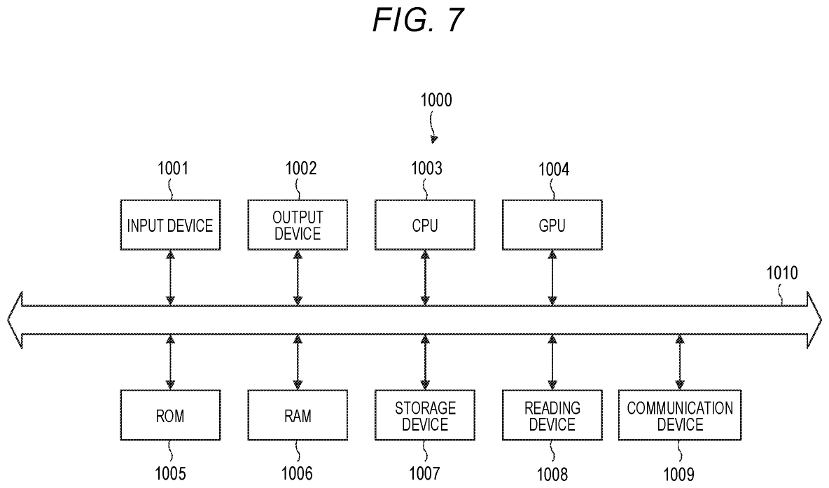

The transport management device 100 includes an information storage unit 101, an information control unit 102, a transporter determination unit 103, a transport control unit 104, a rent-out control unit 105, a key control unit 106, a settlement control unit 107, and a UI control unit 108. These components may be functions implemented by cooperative operation of at least a part of an input device 1001, an output device 1002, a CPU 1003, a GPU 1004, a ROM 1005, a RAM 1006, a storage device 1007, a reading device 1008, and a communication device 1009 illustrated in FIG. 7.

The information storage unit 101 stores information handled by the transport management device 100. For example, the information storage unit 101 stores owner information 121, renter information 122, transporter information 123, vehicle information 124, rent-out state information 125, key information 126, and settlement information 127. The information storage unit 101 may be configured as a database.

The owner information 121 includes information about the owner 3. For example, the owner information 121 includes a company name, an address, a telephone number, and a mail address of the owner 3. When the owner 3 is an individual, the owner information 121 may include a name of the owner 3 instead of the company name.

The renter information 122 includes information about the renter 4. For example, the renter information 122 includes a name, an address, a telephone number, a mail address, and a credit card number of the renter 4.

The transporter information 123 includes information about the transporter 5. For example, the transporter information 123 includes a name, a gender, an address, a telephone number, and a mail address of the transporter 5. In addition, the transporter information 123 may include information 128 indicating a condition under which the transporter 5 accepts the transport work. Hereinafter, the information 128 indicating the condition under which the transporter 5 accepts the transport work is referred to as the condition information 128. The condition information 128 includes, for example, an acceptable vehicle type of a vehicle, an acceptable area, an acceptable minimum reward, and an acceptable scheduled date and time. In addition, the transporter information 123 may include information 129 indicating an evaluation from at least one of the renter 4 and the owner 3 for the past transport work of the transporter 5. Hereinafter, the information 129 indicating the evaluation from the at least one of the renter 4 and the owner 3 for the past transport work of the transporter 5 is referred to as the evaluation information 129. The evaluation information 129 may be an n-grade evaluation (n is an integer of 2 or more) in which magnitude of a score indicates a level of the evaluation. The evaluation information 129 may include a plurality of evaluation items, and may include n-grade evaluation for each evaluation item.

The vehicle information 124 includes information about the vehicle 2 for rent. For example, the vehicle information 124 includes information indicating a vehicle ID, an owner of the vehicle, a vehicle type, a number of a license plate of the vehicle, and options of the vehicle.

The rent-out state information 125 includes information indicating a rent-out state of the vehicle 2. For example, the rent-out state information 125 includes a vehicle ID, a rent-out state of a vehicle, a current position of the vehicle, an owner of the vehicle, a renter of the vehicle, and a rent-out period of the vehicle. The rent-out state of the vehicle may be, for example, any one of a rentable state, a reserved state, a state of being rented out, and a state of being transported.

The key information 126 includes information about a key for unlocking and starting the vehicle 2. For example, the key information 126 includes information indicating key data, the owner terminal 10 which is a distribution destination of the key data, the renter terminal 20, the transporter terminal 30, and an expiration date of the key data. The owner terminal 10, the renter terminal 20, and the transporter terminal 30 in which the key information 126 is stored may operate as a smart key of the vehicle 2 corresponding to the key information 126.

The settlement information 127 includes information about settlement caused by renting of the vehicle 2. For example, the settlement information 127 includes information indicating a vehicle which is rented out, a renter of the vehicle, an owner of the vehicle, a transporter of the vehicle, a rent-out period of the vehicle, a billing amount to the renter, a payment amount to the owner, and a payment amount to the transporter.

The information control unit 102 registers new information in the information storage unit 101, and changes and deletes information stored in the information storage unit 101. When the information storage unit 101 is a database, the information control unit 102 may be a database management system (DBMS).

The transporter determination unit 103 determines the transporter 5 capable of transporting the vehicle 2 for rent to the delivery point designated by the renter 4 of the vehicle 2. The transporter determination unit 103 determines the transporter 5 capable of picking up the vehicle 2 for return at the delivery point designated by the renter 4 of the vehicle 2. The transporter determination unit 103 may determine the transporter 5 based on an instruction from the renter 4. Alternatively, the transporter determination unit 103 may determine the transporter 5 based on an instruction from the owner 3. Alternatively, the transporter determination unit 103 may determine the transporter 5 based on the condition information 128 of each transporter 5.

The transport control unit 104 may transmit, to the transporter terminal 30 of the transporter 5 determined by the transporter determination unit 103, the transport request information including the delivery point of the vehicle 2 for rent designated by the renter 4. In this case, the transport control unit 104 may also include the rent-out point of the vehicle 2 designated by the owner 3 in the transport request information. The transport control unit 104 may transmit, to the transporter terminal 30 of the transporter 5 determined by the transporter determination unit 103, the transport request information including the delivery point of the vehicle 2 for return designated by the renter 4. In this case, the transport control unit 104 may also include the return point of the vehicle 2 designated by the owner 3 in the transport request information.

The rent-out control unit 105 controls the rent-out state information 125 of the vehicle 2. For example, when the rental reservation is made for a certain vehicle 2 by the renter 4, the rent-out control unit 105 changes the rent-out state of the rent-out state information 125 corresponding to the vehicle 2 to a “reserved state”. For example, when the transporter 5 is transporting a certain vehicle 2, the rent-out control unit 105 changes the rent-out state of the rent-out state information 125 corresponding to the vehicle 2 to the state of “being transported”.

The key control unit 106 controls the key information 126. For example, the key control unit 106 generates and deletes the key information 126. The key control unit 106 transmits the key information 126 corresponding to the vehicle 2 to the owner terminal 10, the renter terminal 20, and the transporter terminal 30 of an entity or person who is permitted to use the vehicle 2.

The settlement control unit 107 controls the settlement information 127. For example, when the rental and the return of the vehicle 2 are completed, the settlement control unit 107 calculates a billing amount to the renter 4, a payment amount to the owner 3, a payment amount to the transporter 5, and the like, and generates the settlement information 127.

The UI control unit 108 controls a UI for using a service provided by the transport management device 100 from the owner terminal 10, the renter terminal 20, and the transporter terminal 30. For example, the UI may be a UI of an application for using the service provided by the transport management device 100, which is executed by the owner terminal 10, the renter terminal 20, or the transporter terminal 30. Alternatively, the UI may be a web browser UI of the owner terminal 10, the renter terminal 20, or the transporter terminal 30 that has accessed the service provided by the transport management device 100. The UI control unit 108 may control a UI for an administrator to operate the transport management device 100.

Registration and Update of Information

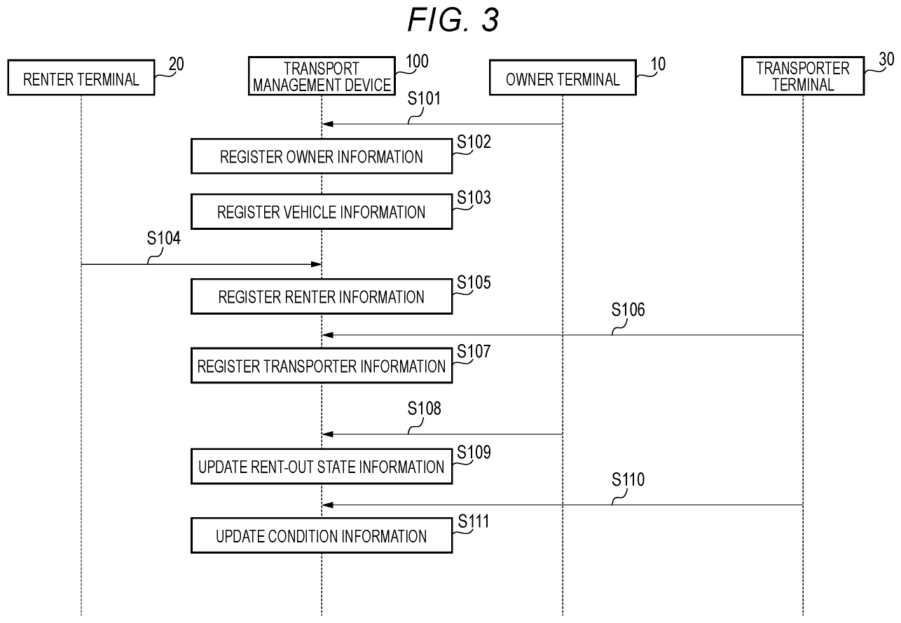

FIG. 3 is a sequence chart illustrating an operation example of the transport management system 1 related to registration of information in the information storage unit 101 of the transport management device 100 and update of information in the information storage unit 101.

The owner 3 transmits the owner information 121 of the owner 3 and the vehicle information 124 of the vehicle 2 rented out by the owner 3 to the transport management device 100 through the owner terminal 10 (S101). The information control unit 102 of the transport management device 100 receives the owner information 121 and the vehicle information 124 in S101, and registers the owner information 121 and the vehicle information 124 in the information storage unit 101 (S102 and S103). The information control unit 102 transmits a registration completion response to the owner terminal 10 (not shown).

The renter 4 transmits the renter information 122 of the renter 4 to the transport management device 100 through the renter terminal 20 (S104). The information control unit 102 of the transport management device 100 receives the renter information 122 in S104 and registers the renter information 122 in the information storage unit 101 (S105). The information control unit 102 transmits a registration completion response to the renter terminal 20 (not shown).

The transporter 5 transmits the transporter information 123 of the transporter 5 to the transport management device 100 through the transporter terminal 30 (S106). The information control unit 102 of the transport management device 100 receives the transporter information 123 in S106 and registers the transporter information 123 in the information storage unit 101 (S107). The information control unit 102 transmits a registration completion response to the transporter terminal 30 (not shown).

When the rent-out state of the vehicle 2 changes, the owner 3 transmits information indicating the changed rent-out state to the transport management device 100 through the owner terminal 10 (S108). For example, when a rental reservation is made for a certain vehicle 2, information indicating that the rent-out state of the vehicle 2 has changed to the rental reservation is transmitted to the transport management device 100. The information control unit 102 of the transport management device 100 receives the information in S108 and updates the rent-out state information 125 based on the information (S109). For example, when the information control unit 102 receives the information indicating that the rent-out state of the vehicle 2 has changed to the rental reservation, the information control unit 102 changes the rent-out state of the rent-out state information 125 corresponding to the vehicle 2 to the “reserved state”. Processes of S108 and S109 may be performed each time the rent-out state changes.

When the condition for accepting the transport work is changed, the transporter 5 transmits information indicating a changed condition to the transport management device 100 through the transporter terminal 30 (S110). For example, when a scheduled date and time at which the transport work can be accepted is changed, the transporter 5 transmits information including the changed date and time to the transport management device 100. The information control unit 102 of the transport management device 100 receives the information in S110 and updates the condition information 128 of the transporter information 123 based on the information (S111). For example, when the information control unit 102 receives the information including the changed scheduled date and time at which the transport work can be accepted, the information control unit 102 updates, to the changed schedule date and time, the condition information 128 in the transporter information 123 of the transporter 5 that has transmitted the information. Processes of S110 and S111 may be performed each time the transporter 5 changes the condition under which the transporter 5 can accept the transport work.

In Case where Renter Selects Transporter when Renting Vehicle

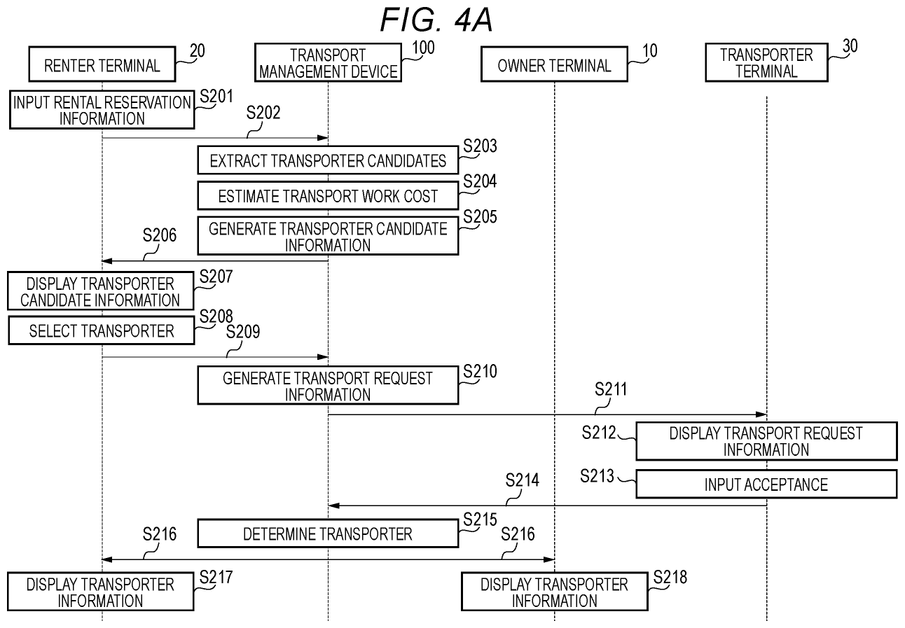

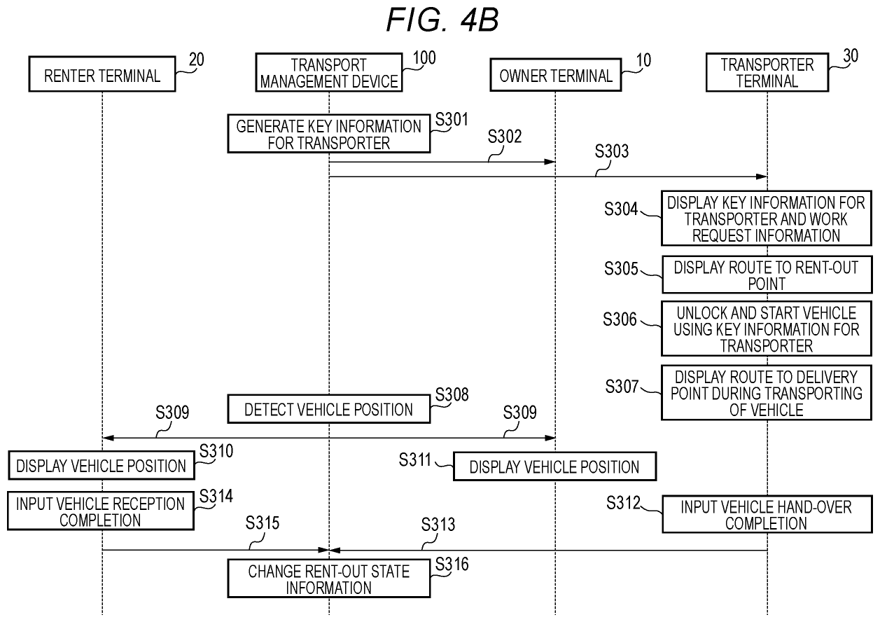

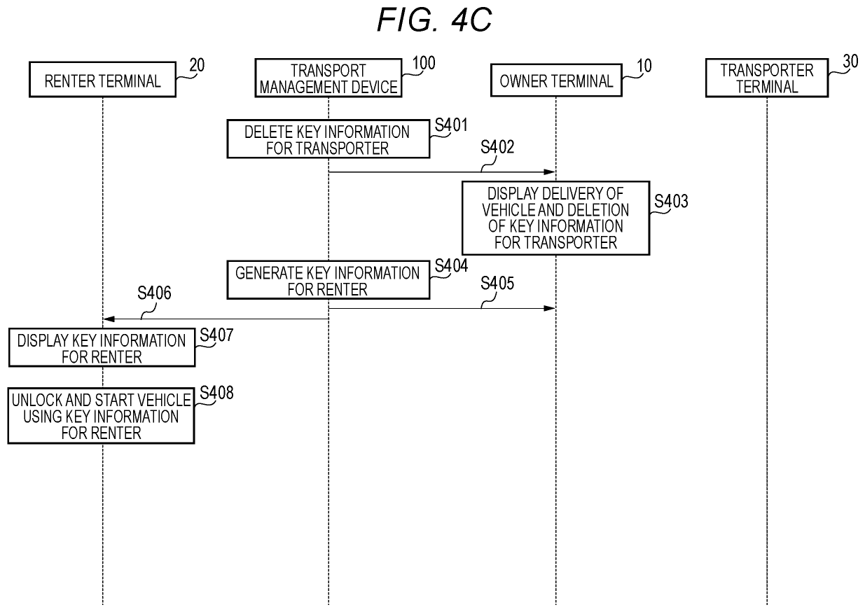

FIGS. 4A to 4C are sequence charts illustrating an operation example of the transport management system 1 in a case where the renter 4 selects the transporter 5 when the vehicle 2 is rented and the selected transporter 5 transports the vehicle 2 for rent to the delivery point designated by the renter 4.

First, processes illustrated in FIG. 4A will be described.

The renter 4 inputs rental reservation information to the renter terminal 20 (S201). For example, the renter 4 inputs, as the rental reservation information, information indicating the vehicle 2 to be rented, the owner of the vehicle 2, a rental period of the vehicle 2, the delivery point of the vehicle 2, a date and time, and the like. The renter terminal 20 transmits the rental reservation information in S201 to the transport management device 100 (S202).

The rent-out control unit 105 of the transport management device 100 receives the rental reservation information in S202. The transporter determination unit 103 extracts the transporter candidates corresponding to the delivery point and the date and time of the vehicle 2 indicated by the rental reservation information based on the condition information 128 of the transporter information 123 stored in the information storage unit 101 (S203). The settlement control unit 107 estimates a transport work cost for each of the extracted transporter candidates (S204). The transport work cost is a cost generated when the transport work is requested. At least a part of the transport work cost is paid to the transporter 5 in charge of the transport work.

The transporter determination unit 103 generates transporter candidate information including the transporter information 123 of each transporter candidate extracted in S203 and transporter candidate information including the transport work cost of each transporter candidate estimated in S204 (S205). The transporter determination unit 103 transmits the transporter candidate information generated in S205 to the renter terminal 20 (S206).

The renter terminal 20 receives and displays the transporter candidate information in S206 (S207). For example, the renter terminal 20 displays a name, a gender, a face image, the evaluation information 129, and the transport work cost of each of the transporter candidates based on the transporter candidate information.

The renter 4 operates the renter terminal 20 to select the transporter 5 who requests the transport of the vehicle 2 reserved for rental from among the transporter candidates displayed in S207 (S208). The renter terminal 20 transmits selection result information indicating the transporter 5 selected in S208 to the transport management device 100 (S209).

The transporter determination unit 103 of the transport management device 100 receives the selection result information in S209, and generates the transport request information for requesting the transporter 5 indicated by the received selection result information to perform the transport work (S210). For example, the transporter determination unit 103 generates the transport request information including a vehicle type of the vehicle 2 to be transported, the rent-out point of the vehicle 2, the delivery point to the renter 4, the date and time, and the like. The transporter determination unit 103 transmits the transport request information in S210 to the transporter terminal 30 of the transporter 5 selected in S208 (S211).

The transporter terminal 30 receives and displays the transport request information in S211 (S212). The transporter 5 looks at the displayed transport request information and determines whether to accept the requested transport work. In a case where the transporter 5 determines to accept the transport work, the transporter 5 inputs acceptance to the transporter terminal 30 (S213). The transporter terminal 30 transmits, to the transport management device 100, an acceptance response indicating that the transporter 5 has accepted the transport work (S214).

The transporter determination unit 103 of the transport management device 100 receives the acceptance response in S214, and determines the transporter 5 that is a transmission source of the acceptance response to be in charge of the transport work (S215). The transporter determination unit 103 transmits the transporter information 123 of the transporter 5 determined in S215 to the renter terminal 20 of the renter 4 reserved for rental in S201 and the owner terminal 10 of the owner 3 of the vehicle 2 reserved for rental in S201 (S216).

Each of the renter terminal 20 and the owner terminal 10 receives the transporter information 123 in S216 and displays the transporter information 123 (S217 and S218). Accordingly, the owner 3 can know in advance what kind of entity or person comes to pick up the vehicle 2 from the transporter information 123 displayed on the owner terminal 10. The renter 4 can know in advance what kind of entity or person comes to hand over the vehicle 2 from the transporter information 123 displayed on the renter terminal 20.

In FIG. 4A, the case where the renter 4 selects the transporter 5 who requests the transport from among the plurality of transporter candidates in S208 has been described, but a determination method of the transporter 5 is not limited thereto. For example, the transporter determination unit 103 may automatically determine one transporter 5 from among the plurality of transporter candidates extracted in S203 based on a predetermined rule. In this case, the processes of S207 to S209 may not be executed.

Next, processes illustrated in FIG. 4B following FIG. 4A will be described.

The key control unit 106 of the transport management device 100 generates the key information 126 for the transporter 5 determined in S215 (S301). The key control unit 106 transmits, to the owner terminal 10, key right addition information indicating that the key information 126 for the transporter 5 is generated (S302).

The owner terminal 10 receives the key right addition information in S302. From the key right addition information, the owner terminal 10 can recognize that the transporter 5 determined in S215 is added as an entity or person who can unlock and start the vehicle 2 reserved for rental.

The key control unit 106 transmits the key information 126 for the transporter 5 in S301 to the transporter terminal 30 (S303).

The transporter terminal 30 receives and stores the key information 126 for the transporter 5 in S303. The transporter terminal 30 displays the key information 126 for the transporter 5 and the transport request information received in S211 (S304). In addition, the transporter terminal 30 displays a route and navigation to the rent-out point of the vehicle 2 for rent, based on the transport request information (S305). Accordingly, the transporter 5 can easily arrive at the rent-out point of the vehicle 2. The rent-out point may be designated by the owner 3. The owner 3 may not be at the rent-out point as long as the vehicle 2 for rent is present at the rent-out point.

The transporter 5 arrives at the rent-out point and unlocks and starts the vehicle 2 for rent using the key information 126 for the transporter 5 stored in the transporter terminal 30 (S306). In this way, by using the key information 126 instead of a physical key, the transporter 5 can unlock and start the vehicle 2 for rent even if the transporter 5 does not directly meet the owner 3.

The transporter 5 drives the vehicle 2 toward the delivery point designated by the renter 4. At this time, the transporter terminal 30 displays the route and the navigation to the delivery point (S307). Accordingly, the transporter 5 can easily arrive at the delivery point.

The transport control unit 104 of the transport management device 100 detects a current position of the vehicle 2 at any time while the transporter 5 transports the vehicle 2 toward the delivery point (S308). The transport control unit 104 transmits vehicle position information indicating the detected current position of the vehicle 2 to the renter terminal 20 and the owner terminal 10 (S309).

Each of the renter terminal 20 and the owner terminal 10 receives the vehicle position information in S309 and displays the current position of the vehicle 2 (S310, S311). Accordingly, the renter 4 and the owner 3 can know whether the vehicle 2 is being transported by the transporter 5 without any problem by looking at the displayed current position of the vehicle 2.

The transporter 5 hands over the vehicle 2 to the renter 4 at the delivery point, and inputs, to the transporter terminal 30, hand-over completion information indicating that the handing over of the vehicle 2 is completed (S312). The transporter terminal 30 transmits the hand-over completion information input in S312 to the transport management device 100 (S313).

The renter 4 receives the vehicle 2 from the transporter 5 at the delivery point, and inputs, to the renter terminal 20, reception completion information indicating that the reception of the vehicle 2 is completed (S314). The renter terminal 20 transmits the reception completion information input in S314 to the transport management device 100 (S315).

The rent-out control unit 105 of the transport management device 100 receives the hand-over completion information in S313 and the reception completion information in S315, and changes the rent-out state of the rent-out state information 125 of the vehicle 2 from a state of “being transported” to a state of “being rented” (S316).

Next, processes illustrated in FIG. 4C following FIG. 4B will be described.

The key control unit 106 of the transport management device 100 deletes the key information 126 for the transporter 5 (S401). The transport control unit 104 transmits, to the owner terminal 10, information indicating that the vehicle 2 is handed over from the transporter 5 to the renter 4 and that the key information 126 for the transporter 5 is deleted (S402).

The owner terminal 10 receives the information in S402. Based on the received information, the owner terminal 10 displays the information indicating that the vehicle 2 is handed over from the transporter 5 to the renter 4 and that the key information 126 for the transporter 5 is deleted (S403).

The key control unit 106 of the transport management device 100 generates the key information 126 for the renter 4 (S404). The key control unit 106 transmits, to the owner terminal 10, the key right addition information indicating that the key information 126 for the renter 4 is generated (S405). The owner terminal 10 receives the key right addition information in S405. From the key right addition information, the owner terminal 10 recognizes that the renter 4 is added as the entity or person who can unlock and start the vehicle 2 reserved for rental.

The key control unit 106 transmits the key information 126 for the renter 4 generated in S404 to the renter terminal 20 (S406). The renter terminal 20 receives and displays the key information 126 for the renter 4 in S406 (S407). The renter 4 unlocks and starts the vehicle 2 using the key information 126 for the renter 4 received by the renter terminal 20 (S408). Accordingly, the renter 4 can use the rented vehicle 2.

In Case where Owner Selects Transporter when Renting Out Vehicle

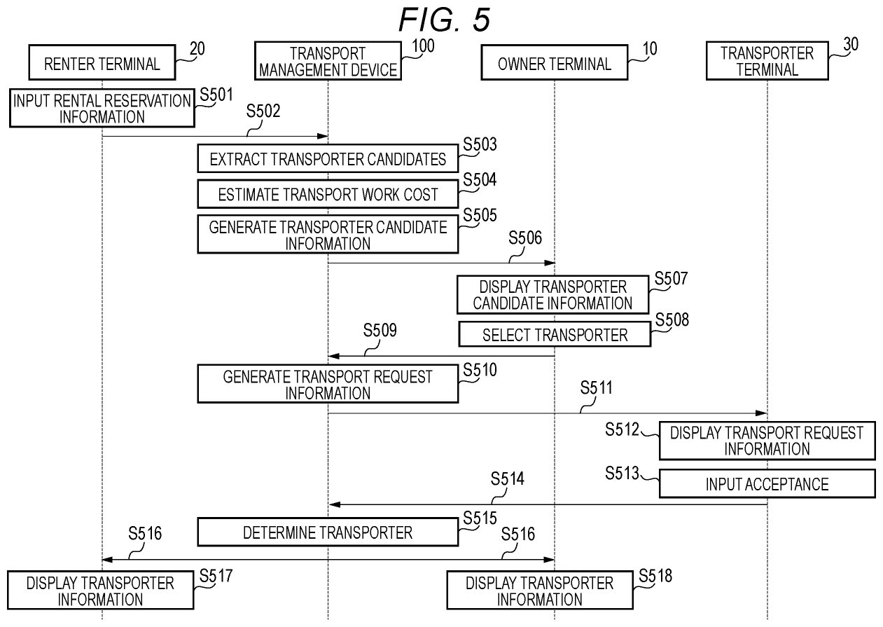

FIG. 5 is a sequence chart illustrating an operation example of the transport management system 1 in a case where the owner 3 selects the transporter 5 when the vehicle 2 is rented out, and the selected transporter 5 transports the vehicle 2 for rent to the delivery point designated by the renter 4.

Similarly to S201 in FIG. 4A, the renter 4 inputs the rental reservation information to the renter terminal 20 (S501).

The rent-out control unit 105 of the transport management device 100 receives the rental reservation information in S502. The transporter determination unit 103 and the settlement control unit 107 perform the same processes as S203 to S205 of FIG. 4A (S503 to S505). The transporter determination unit 103 transmits the transporter candidate information generated in S505 to the owner terminal 10 (S506).

The owner terminal 10 receives and displays the transporter candidate information in S506 (S507). For example, the owner terminal 10 displays the name, the gender, the face image, the evaluation information 129, and the transport work cost of each of the transporter candidates based on the transporter candidate information.

The owner 3 operates the owner terminal 10 to select the transporter 5 who requests the transport of the vehicle 2 reserved for rental in S501 from among the transporter candidates displayed in S507 (S508). The owner terminal 10 transmits the selection result information indicating the transporter 5 selected in S508 to the transport management device 100 (S509).

Thereafter, the transport management system 1 performs the same processes as S210 to S218 in FIG. 4A (S510 to S518). The subsequent processes are also the same as the processes illustrated in FIGS. 4B and 4C, and thus a description thereof will be omitted.

In FIG. 5, the case where the owner 3 selects the transporter 5 who requests the transport from among the plurality of transporter candidates in S508 has been described, but a determination method of the transporter 5 is not limited thereto. For example, the transporter determination unit 103 may automatically determine one transporter 5 from among the plurality of transporter candidates extracted in S503 based on the predetermined rule. In this case, the processes of S507 and S508 may not be executed. Alternatively, the transporter determination unit 103 may automatically determine an entity or person designated in advance by the owner 3 as the transporter 5. In this case, the processes of S503 and S505 to S509 may not be executed.

In Case where Renter Selects Transporter when Returning Vehicle

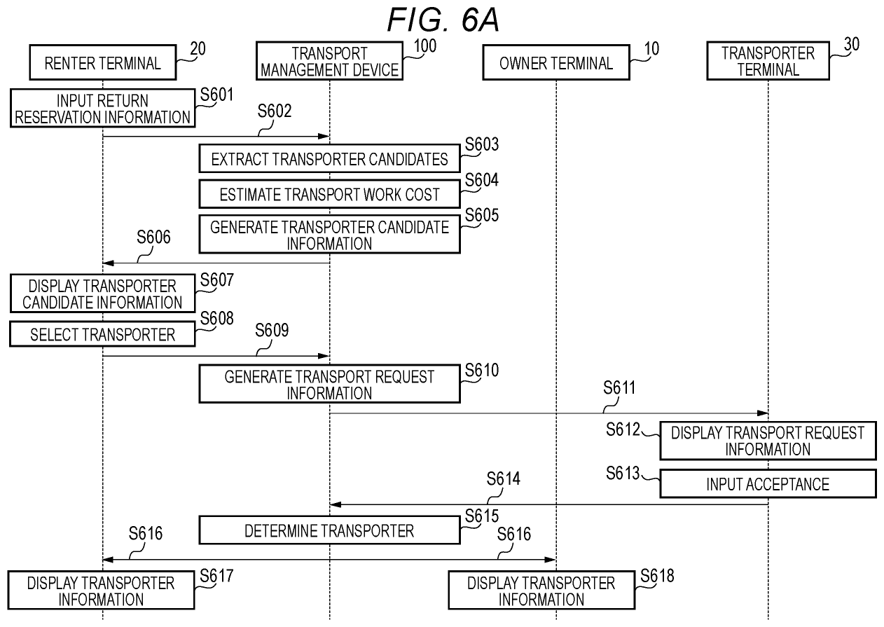

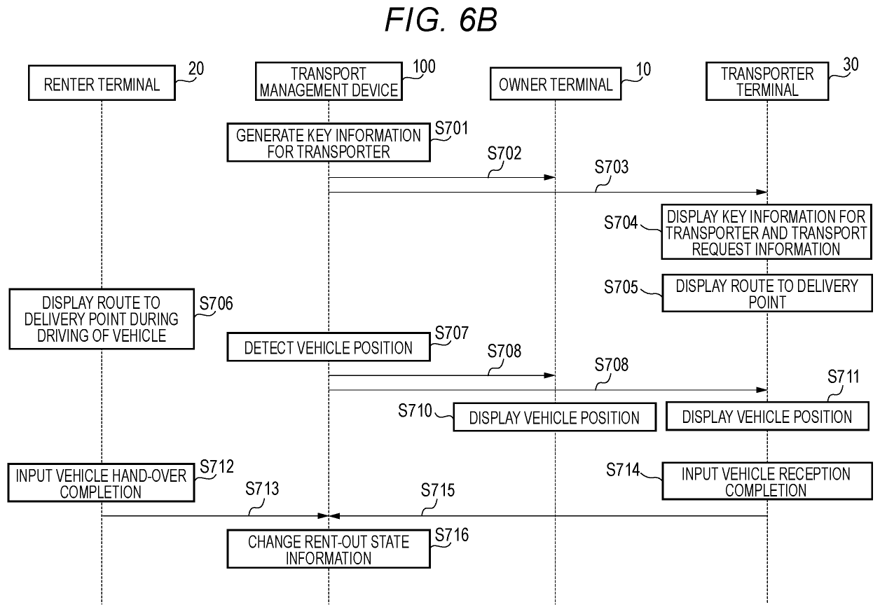

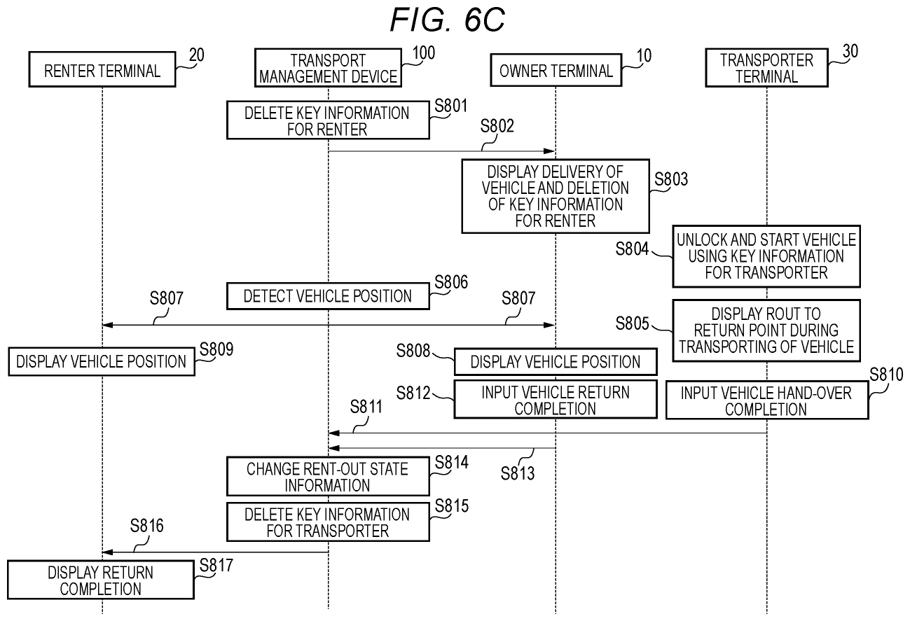

FIGS. 6A to 6C are sequence charts illustrating an operation example of the transport management system 1 in a case where the renter 4 selects the transporter 5 when returning the vehicle 2 and the selected transporter 5 goes to the delivery point designated by the renter 4 to pick up the vehicle 2 for return.

First, processes illustrated in FIG. 6A will be described.

The renter 4 inputs return reservation information to the renter terminal 20 (S601). For example, the renter 4 inputs, as the return reservation information, information indicating the vehicle 2 for return, the delivery point of the vehicle 2, the date and time, and the like. The renter terminal 20 transmits the return reservation information in S601 to the transport management device 100 (S602). The renter 4 may input the return reservation information in advance at the time of making rental reservation.

The rent-out control unit 105 of the transport management device 100 receives the return reservation information in S5602. The transporter determination unit 103 extracts the transporter candidates corresponding to the delivery point and the date and time of the vehicle 2 indicated by the return reservation information based on the condition information 128 of the transporter information 123 stored in the information storage unit 101 (S603). The settlement control unit 107 estimates the transport work cost for each of the extracted transporter candidates (S604).

The transporter determination unit 103 generates the transporter candidate information including the transporter information 123 of each transporter candidate extracted in S603 and the transport work cost of each transporter candidate estimated in S604 (S605). The transport control unit 104 transmits the transporter candidate information generated in S605 to the renter terminal 20 (S606).

The renter terminal 20 receives and displays the transporter candidate information in S606 (S607).

The renter 4 operates the renter terminal 20 to select the transporter 5 who requests the transport of the vehicle 2 reserved for return from among the transporter candidates displayed in S607 (S608). The renter terminal 20 transmits selection result information indicating the transporter 5 selected in S608 to the transport management device 100 (S609). Thereafter, the transport management system 1 performs the same processes as S210 to S218 in FIG. 4A (S610 to S618).

In FIG. 6A, the case where the renter 4 selects the transporter 5 who requests the transport from among the plurality of transporter candidates in S608 has been described, but a determination method of the transporter 5 is not limited thereto. For example, the transporter determination unit 103 may automatically determine one transporter 5 from among the plurality of transporter candidates extracted in S603 based on the predetermined rule. In this case, the processes of S607 to S609 may not be executed. Alternatively, the transporter determination unit 103 may set the transporter 5 in charge of transport at the time of renting out the vehicle 2 as a first candidate at the time of returning, and preferentially transmit the transport request information to the transporter terminal 30 of the transporter 5.

Next, processes illustrated in FIG. 6B following FIG. 6A will be described.

The key control unit 106 of the transport management device 100 generates the key information 126 for the transporter 5 determined in S615 (S701). The key control unit 106 transmits, to the owner terminal 10, the key right addition information indicating that the key information 126 for the transporter 5 is generated (S702).

The owner terminal 10 receives the key right addition information in S702. From the key right addition information, the owner terminal 10 can recognize that the transporter 5 determined in S615 is added as an entity or person who can unlock and start the vehicle 2 reserved for return.

The key control unit 106 transmits the key information 126 for the transporter 5 in S701 to the transporter terminal 30 (S703).

The transporter terminal 30 receives and stores the key information 126 for the transporter 5 in S703. The transporter terminal 30 displays the key information 126 for the transporter 5 and the transport request information received in S611 (S704). In addition, the transporter terminal 30 displays the route and the navigation to the delivery point of the vehicle 2 for return based on the transport request information (S705). Accordingly, the transporter 5 can easily arrive at the delivery point. The transporter 5 waits for arrival of the renter 4 and the vehicle 2 for return at the delivery point.

On the other hand, the renter 4 drives the vehicle 2 for return toward the delivery point. During driving of the vehicle 2, the renter terminal 20 displays the route and the navigation to the delivery point (S706). In a case where the vehicle 2 for return is already present at the delivery point, the process of S706 may not be executed as in a case where the home is designated as the delivery point.

The transport control unit 104 of the transport management device 100 detects the current position of the vehicle 2 at any time while the renter 4 drives the vehicle 2 toward the delivery point (S707). Further, the transport control unit 104 transmits the vehicle position information indicating the detected current position of the vehicle 2 to the owner terminal 10 and the transporter terminal 30 (S708).

Each of the owner terminal 10 and the transporter terminal 30 receives the vehicle position information in S708 and displays the current position of the vehicle 2 (S710 and S711). Accordingly, the owner 3 and the transporter 5 can know whether the renter 4 is driving the vehicle 2 toward the delivery point without any problem by looking at the displayed current position of the vehicle 2.

The renter 4 hands over the vehicle 2 for return to the transporter 5 at the delivery point, and inputs, to the transporter terminal 30, the hand-over completion information indicating that the handing over of the vehicle 2 for return is completed (S712). The renter terminal 20 transmits the hand-over completion information input in S712 to the transport management device 100 (S713).

The transporter 5 picks up the vehicle 2 for return from the renter 4 at the delivery point, and inputs, to the transporter terminal 30, the reception completion information indicating that the reception of the vehicle 2 for return is completed (S714). The transporter terminal 30 transmits the reception completion information input in S714 to the transport management device 100 (S715).

The transport control unit 104 of the transport management device 100 receives the hand-over completion information in S713 and the reception completion information in S715, and changes the rent-out state of the rent-out state information 125 of the vehicle 2 from the state of “being rented” to the state of “being transported” (716).

Next, processes illustrated in FIG. 6C following FIG. 6B will be described.

The key control unit 106 of the transport management device 100 deletes the key information 126 for the renter 4 (S801). The transport control unit 104 transmits, to the owner terminal 10, information indicating that the vehicle 2 is handed over from the renter 4 to the transporter 5 and that the key information 126 for the renter 4 is deleted (S802).

The owner terminal 10 receives the information in S802. Based on the received information, the owner terminal 10 displays the information indicating that the vehicle 2 is handed over from the renter 4 to the transporter 5 and that the key information 126 for the renter 4 is deleted (S803).

Further, the transporter 5 unlocks and starts the vehicle 2 for return picked up from the renter 4 using the key information 126 for the transporter 5 stored in the transporter terminal 30 (S804).

The transporter 5 drives the vehicle 2 toward the return point. At this time, the transporter terminal 30 displays a route and navigation to the return point (S805). Accordingly, the transporter 5 can easily arrive at the return point.

The transport control unit 104 of the transport management device 100 detects the current position of the vehicle 2 at any time while the transporter 5 transports the vehicle 2 toward the return point (S806). The transport control unit 104 transmits the vehicle position information indicating the detected current position of the vehicle 2 to the owner terminal 10 and the renter terminal 20 (S 807).

Each of the owner terminal 10 and the renter terminal 20 receives the vehicle position information in S807 and displays the current position of the vehicle 2 (S808, S809). Accordingly, the owner 3 and the renter 4 can know whether the vehicle 2 is being transported by the transporter 5 without any problem by looking at the displayed current position of the vehicle 2.

The transporter 5 hands over the vehicle 2 to the owner 3 at the return point, and inputs, to the transporter terminal 30, the hand-over completion information indicating that the handing over of the vehicle 2 is completed (S810). The transporter terminal 30 transmits the hand-over completion information input in S810 to the transport management device 100 (S811).

The owner 3 receives the vehicle 2 from the transporter 5 at the return point, and inputs, to the owner terminal 10, return completion information indicating that the return of the vehicle 2 is completed (S812). The owner terminal 10 transmits the return completion information input in S812 to the transport management device 100 (S813). The return point may be designated by the owner 3. The owner 3 may not be at the return point as long as the vehicle 2 for return is returned to the return point.

The rent-out control unit 105 of the transport management device 100 receives the hand-over completion information in S811 and the return completion information in S813, and changes the rent-out state of the rent-out state information 125 of the vehicle 2 from the state of “being transported” to a “rentable” state (S814).

The key control unit 106 of the transport management device 100 deletes the key information 126 for the transporter 5 (S815). The transport control unit 104 transmits the return completion information indicating that the return of the vehicle 2 is completed to the renter terminal 20 (S816). The renter terminal 20 receives and displays the return completion information of S816 (S817). Accordingly, the renter 4 can know that the vehicle 2 is returned without any problem. By using the key information 126 instead of the physical key in this manner, the transporter 5 can save a trouble of meeting the owner 3 directly and returning the physical key.

Modifications

In the above description, the case where the owner terminal 10, the renter terminal 20, and the transporter terminal 30 are used as keys of the vehicle 2 by downloading the key information 126 to the owner terminal 10, the renter terminal 20, and the transporter terminal 30 has been described, but a physical key of the vehicle 2 may be used instead of the key information 126. In this case, the transporter 5 may pick up the physical key of the vehicle 2 for rent from the owner 3 at the rent-out point, and may deliver the physical key together with the vehicle 2 to the renter 4. The transporter 5 may pick up the physical key together with the vehicle 2 for return from the renter 4, and may deliver the physical key together with the vehicle 2 to the owner 3 at the return point.

Hardware Configuration

Although the embodiments according to the present disclosure have been described in detail with reference to the drawings, functions of the transport management device 100, the owner terminal 10, the renter terminal 20, and the transporter terminal 30 described above may be implemented with a computer program.

FIG. 7 is a diagram illustrating a hardware configuration of a computer that implements the functions of the transport management device 100, the owner terminal 10, the renter terminal 20, and the transporter terminal 30 according to the present disclosure by a program.

A computer 1000 includes the input device 1001, the output device 1002, the central processing unit (CPU) 1003, the graphics processing unit (GPU) 1004, the read only memory (ROM) 1005, the random access memory (RAM) 1006, the storage device 1007, the reading device 1008 that reads information from a recording medium, and the communication device 1009 that performs communication via the communication network 6. The input device 1001, the output device 1002, the CPU 1003, the GPU 1004, the ROM 1005, the RAM 1006, the storage device 1007, the reading device 1008, and the communication device 1009 are connected by a bus 1010 capable of bidirectional communication. The input device 1001 is, for example, a keyboard, a mouse, or a touch pad. The output device 1002 is, for example, a display or a speaker. The storage device 1007 is, for example, a hard disk drive (HDD) or a solid state drive (SSD). The recording medium is, for example, a digital versatile disk read only memory (DVD-ROM) or a universal serial bus (USB) memory.

The reading device 1008 reads a program for implementing the functions of the transport management device 100, the owner terminal 10, the renter terminal 20, and the transporter terminal 30 from the recording medium in which the program is recorded, and causes the storage device 1007 to store the program. Alternatively, the communication device 1009 communicates with a predetermined server device connected to the communication network 6, and causes the storage device 1007 to store a program for implementing the functions of the transport management device 100, the owner terminal 10, the renter terminal 20, and the transporter terminal 30 downloaded from the server device.

The CPU 1003 copies the program stored in the storage device 1007 to the RAM 1006, and sequentially reads and executes instructions in the program from the RAM 1006, thereby implementing the functions of the transport management device 100, the owner terminal 10, the renter terminal 20, and the transporter terminal 30.

The CPU 1003 may be replaced with as another term such as a processor, a controller, an arithmetic circuit, or a control unit. At least one of the RAM 1006 and the storage device 1007 may be replaced with another term such as a memory or a storage unit. The communication device 1009 may be replaced with another term such as a transmission/reception device, a communication interface, a communication module, or a communication unit.

Each functional block used in the description of the above embodiments is typically implemented as an LSI which is an integrated circuit. These function blocks may be individually integrated into one chip, or may be integrated into one chip so as to include a part or all of them. Here, the term “LSI” is used, but the term “IC”, “system LSI”, “super LSI”, or “ultra LSI” may be used depending on the degree of integration. Further, if a circuit integration technology that replaces the LSI emerges due to a progress of a semiconductor technology or another derivative technology, the technology may naturally be used to integrate the functional blocks.

Summary of Present Disclosure

A transport management device 100 that manages transport of a vehicle 2 for rent according to the present disclosure includes: an information storage unit 101 configured to store transporter information 123 including information about a transporter 5 who transports the vehicle 2 between an owner 3 and a renter 4 of the vehicle; and a transporter determination unit 103 configured to determine, based on the transporter information 123, the transporter 5 capable of picking up the vehicle 2 at a first point designated by the owner 3 and transporting the picked-up vehicle 2 to a second point designated by the renter 4, and transmit, to a terminal 30 of the determined transporter 5, transport request information including information indicating the first point and the second point. According to this configuration, based on the transport request information transmitted to the terminal 30 of the transporter, the transporter 5 can pick up the vehicle 2 for rent at the first point designated by the owner 3 and transport the vehicle 2 to the second point designated by the renter 4. The renter 4 can receive the vehicle 2 for rent from the transporter 5 at the designated second point. That is, it is possible to efficiently transport the vehicle 2 between the owner 3 and the renter 4 of the vehicle 2.

The transporter determination unit 103 may determine, based on the transporter information 123, the transporter 5 capable of picking up the vehicle 2 at a third point designated by the renter 4 and transporting the picked-up vehicle 2 to a fourth point designated by the owner 3, and transmit, to the terminal 30 of the determined transporter, the transport request information including information indicating the third point and the fourth point. According to this configuration, based on the transport request information transmitted to the terminal 30 of the transporter, the transporter 5 can pick up the vehicle 2 for return at the third point designated by the renter 4 and transport the vehicle 2 to the fourth point designated by the owner 3. The renter 4 can hand over the vehicle 2 for return to the transporter 5 at the designated third point. That is, it is possible to efficiently transport the vehicle 2 between the owner 3 and the renter 4 of the vehicle 2.

The transporter determination unit 103 may determine the transporter 5 of the vehicle 2 based on condition information 128 provided in the transporter information 123 and indicating a condition under which the transporter 5 accepts the transport. According to this configuration, the transporter determination unit 103 can determine the transporter 5 of the vehicle 2 based on the condition information 128 of each transporter 5.

The transporter determination unit 103 may extract the transporters 5 matching the condition information 128 as transporter candidates, transmit information indicating the transporter candidates to a terminal 20 of the renter, and determine, as the transporter of the vehicle 2, an entity or person selected by the renter 4 from among the transporter candidates through the terminal 20. According to this configuration, the renter 4 can easily determine the transporter 5 who requests the transport from among the transporter candidates matching the condition information 128.

The transporter determination unit 103 may extract the transporters 5 matching the condition information 128 as transporter candidates, transmit information indicating the transporter candidates to a terminal 10 of the owner, and determine, as the transporter 5 of the vehicle 2, an entity or person selected by the owner 3 from among the transporter candidates through the terminal 10. According to this configuration, the owner 3 can easily determine the transporter 5 who requests the transport from among the transporter candidates matching the condition information 128.

The transporter determination unit 103 may transmit information indicating the determined transporter 5 of the vehicle 2 to at least one of a terminal 10 of the owner and a terminal 20 of the renter. According to this configuration, at least one of the owner 3 and the renter 4 can know in advance what kind of transporter 5 comes to take or deliver the vehicle 2.

The transport management device 100 may further include: a transport control unit 104 configured to transmit information indicating a position of the vehicle 2 to at least one of a terminal 20 of the renter and a terminal 10 of the owner during transporting of the vehicle 2 by the transporter 5. According to this configuration, since at least one of the renter 4 and the owner 3 can know the position of the vehicle 2 being transported, it is possible to determine whether the vehicle 2 is transported without any problem.

The transport management device 100 may further include: a key control unit 106 configured to transmit, to the terminal 30 of the transporter determined by the transporter determination unit 103, key information 126 capable of unlocking and starting the vehicle 2. According to this configuration, the transporter 5 can unlock and start the vehicle 2 for transport using the key information 126 received by the terminal 30 of the transporter without delivering the physical key of the vehicle 2.

Although the embodiments have been described above with reference to the accompanying drawings, the present disclosure is not limited to such an example. It is apparent to those skilled in the art that various modifications, corrections, substitutions, additions, deletions, and equivalents can be conceived within the scope described in the claims, and it should be understood that such modifications, substitutions, additions, deletions, and equivalents also fall within the technical scope of the present disclosure. Components in the above-mentioned embodiments may be combined as desired within a range not departing from the spirit of the invention.

The present application is based on a Japanese Patent Application (Japanese Patent Application No. 2020-133266) filed on Aug. 5, 2020, and the contents thereof are incorporated herein by reference.

The technology of the present disclosure can be used for a service of renting a vehicle.

What is claimed is:

1. A transport management device configured to manage transport of a vehicle for rent, the transport management device comprising:
a memory; and
a processor that is coupled to the memory, and when executing a program stored in the memory, performs operations comprising:
determining, based on transporter information including information about one or more transporters who transport the vehicle between an owner of the vehicle and a renter of the vehicle, a first transporter from among the one or more transporters, the first transporter being capable of picking up the vehicle at a first point designated by the owner and transporting the vehicle picked up at the first point to a second point designated by the renter; and
transmitting, to a terminal of the first transporter, first transport request information including information indicating the first point and the second point.

2. The transport management device according to claim 1, wherein the operations further comprise:
determining the first transporter based on condition information contained in the transporter information, the condition information indicating conditions acceptable to the one or more transporters, respectively.

3. The transport management device according to claim 2, wherein the operations further comprise:
extracting one or more transporter candidates from among the one or more transporters, the one or more transporter candidates matching the condition information;
transmitting information indicating the one or more transporter candidates to a terminal of the renter; and
determining, to be the first transporter, one of the one or more transporter candidates being selected by the renter through the terminal of the renter.

4. The transport management device according to claim 2, wherein the operations further comprise:
extracting one or more transporter candidates from among the one or more transporters, the one or more transporter candidates matching the condition information;
transmitting information indicating the one or more transporter candidates to a terminal of the owner; and
determining, to be the first transporter, one of the one or more transporter candidates being selected by the owner through the terminal of the owner.

5. The transport management device according to claim 1, wherein the operations further comprise:
transmitting information indicating the first transporter to at least one of a terminal of the owner and a terminal of the renter.

6. The transport management device according to claim 1, wherein the operations further comprise:
transmitting information indicating a position of the vehicle to at least one of a terminal of the renter and a terminal of the owner during transporting of the vehicle by the first transporter.

7. The transport management device according to claim 1, wherein the operations further comprise:
transmitting first key information to the terminal of the first transporter, the first key information enabling unlock and start of the vehicle.

8. The transport management device according to claim 7, wherein the operations further comprise:
deleting the first key information in response to delivery of the vehicle from the first transporter to the renter.

9. The transport management device according to claim 7, wherein the operations further comprise:
transmitting second key information to a terminal of the renter in response to delivery of the vehicle from the first transporter to the renter, the second key information enabling unlock and start of the vehicle.

10. The transport management device according to claim 1, wherein the operations further comprise:
determining, based on the transporter information, a second transporter from among the one or more transporters, the second transporter being capable of picking up the vehicle at a third point designated by the renter and transporting the vehicle picked up at the third point to a fourth point designated by the owner; and
transmitting, to a terminal of the second determined transporter, second transport request information including information indicating the third point and the fourth point.

11. The transport management device according to claim 10, wherein the operations further comprise:
determining the second transporter based on condition information contained in the transporter information, the condition information indicating conditions acceptable to the one or more transporters, respectively.

12. The transport management device according to claim 11, wherein the operations further comprise:
extracting one or more transporter candidates from among the one or more transporters, the one or more transporter candidates matching the condition information;
transmitting information indicating the one or more transporter candidates to a terminal of the renter; and
determining, to be the second transporter, one of the one or more transporter candidates being selected by the renter through the terminal of the renter.

13. The transport management device according to claim 11, wherein the operations further comprise:
extracting one or more transporter candidates from among the one or more transporters, the one or more transporter candidates matching the condition information;
transmitting information indicating the one or more transporter candidates to a terminal of the owner; and
determining, to be the second transporter, one of the one or more transporter candidates being selected by the owner through the terminal of the owner.

14. The transport management device according to claim 10, wherein the operations further comprise:
transmitting information indicating the second transporter to at least one of a terminal of the owner and a terminal of the renter.

15. The transport management device according to claim 10, wherein the operations further comprise:
transmitting information indicating a position of the vehicle to at least one of a terminal of the renter and a terminal of the owner during transporting of the vehicle by the second transporter.

16. The transport management device according to claim 10, wherein the operations further comprise:
transmitting third key information to the terminal of the second transporter, the third key information enabling unlock and start of the vehicle.

17. The transport management device according to claim 16, wherein the operations further comprise:
deleting the second key information in response to pickup of the vehicle by the second transporter from the renter.

18. The transport management device according to claim 16, wherein the operations further comprise:
deleting the third key information in response to delivery of the vehicle from the second transporter to the owner.

19. A transport management system configured to manage transport of a vehicle for rent, the transport management system comprising:
one or more terminals of respective one or more transporters who transport the vehicle between an owner of the vehicle and a renter of the vehicle; and
a transport management device,
wherein the transport management device comprises:
a memory; and
a processor that is coupled to the memory, and when executing a program stored in the memory, performs operations comprising:
determining, based on transporter information including information about the one or more transporters, a first transporter from among the one or more transporters, the first transporter being capable of picking up the vehicle at a first point designated by the owner and transporting the vehicle picked up at the first point to a second point designated by the renter; and
transmitting, to a terminal of the first transporter among the one or more terminals, first transport request information including information indicating the first point and the second point.

20. A transport management method for managing transport of a vehicle for rent by a transport management device, the transport management method comprising:
determining, based on transporter information including information about one or more transporters who transport the vehicle between an owner of the vehicle and a renter of the vehicle, a first transporter from among the one or more transporters, the first transporter being capable of picking up the vehicle at a first point designated by the owner and transporting the vehicle picked up at the first point to a second point designated by the renter; and
transmitting, to a terminal of the first transporter, first transport request information including information indicating the first point and the second point.
